(19) United States
(12) Patent Application Publication
(10) Pub. No.: US 2014/0021754 A1
(43) Pub. Date: Jan. 23, 2014

(54) SMART CAR SEAT AND MANUFACTURING METHOD THEREOF

(71) Applicant: DAS CORPORATION, Gyeongsangbuk-do (KR)

(72) Inventors: Gi-Deuk Jung, Gyeongbuk (KR); Jun-Sik Hwang, Ulsan (KR); Pyung-Hoe Kim, Ulsan (KR)

(73) Assignee: DAS Corporation, Gyeongsangbuk-do (KR)

(21) Appl. No.: 13/673,646

(22) Filed: Nov. 9, 2012

(30) Foreign Application Priority Data
Jul. 20, 2012 (KR) 10-2012-0079162

(51) Int. Cl. B60N 2/44; B60N 2/58; B60N 2/48; B60N 2/68; B60N 2/64

(52) U.S. Cl. CPC B60N 2/44; B60N 2/68; B60N 2/64; B60N 2/4805; B60N 2/58
USPC 297/217.6; 29/407.01

(57) ABSTRACT

Disclosed in the smart car seat manufacture method, which features in that the smart car seat is manufactured in such a way that the cushion pad assembly supporting the user's hips is assembled with the cushion cover covered on the cushion pad, and the back pad assembly is assembled, which supports the sit passenger's back with the light emitting raw sheet sewed on the back cover so as to form the portion which is exposed to the outside along with the back cover covered on the back pad. The smart car seat comprises the back frame, the cushion frame and the light emitting raw sheet processed along with the head rest by way of the finish process.

### CROSS-REFERENCE(S) TO RELATED APPLICATIONS

This application claims priority to Korean Patent Application No. 10-2012-0079162, filed on Jul. 20, 2012, which is incorporated herein by reference in its entirety.

### BACKGROUND OF THE INVENTION

1. Field of the Invention

The present invention relates to a car seat manufacturing method, and particularly to a car seat manufacturing method which makes it possible to more easily manufacture a smart car seat which provides different illuminating effects, a good product quality and enhanced product reliability.

2. Description of Related Art

A car seat is generally manufactured in such a way that a pad formed of an urethane foam cushion material is engaged to a frame defining a seat frame, and a cover made of a woven material or leather and a sheet type of a trim piece material is covered on it, thus completing the manufacture of a car seat with an esthetic looking.

It is known that a car seat is manufactured using a module unit grouped with related elements. Each module unit is coupled and assembled in a manufacture line connected with a plurality of conveyors, thus finally manufacturing a car seat.

The above mentioned manufacture process is generally classified into an assembly process, a check process and a packing process. In each process are provided various facilities for the work of a sub-assembly line and a conveyor line.

The structure and shape of a car seat manufacturing facility are designed to match with a previously set car seat, so a car seat manufactured in one car seat manufacturing facility can have only one specification. For this reason, when it is needed to manufacture a car seat with different specifications, the car seat manufacturing facility should be improved or design-changed for the sake of the different car seat specifications.

However since the different standards are allowed only for a specific element among many elements of a car seat, the usability of it becomes very limited

In particular, a vehicle is demanded to equip with an environmentally friendly feature, so the car seat should be designed to have a smart concept reflected with an entertainment emotion in addition to the five-feeling features along with an esthetic good looking and convenience feature. So, it is needed to try to change the specifications of the car seat in many ways.

As an example of the smart concept, there is an illuminating effect in which the sounds and luminance generating inside or outside a vehicle and the openings of the doors and the fastened state of passengers' seat belt and the over speed of a vehicle are indicated on a car seat.

The car seat that the above mentioned illuminating effect is adapted to is generally called as a smart car seat.

In order for the smart car seat to have such an illuminating effect, a smart device such as a light emitting raw sheet woven with a light emitting raw thread which reacts to light and a controller LED light sources enabling the light emitting raw sheet to emit different colors are needed. As the above mentioned smart devices are assembled to the car seat, the assembling and manufacturing processes of a conventional car seat are inevitably changed in different ways.

So, the assembly and manufacture of the smart car seat with an illuminating effect are not available with an existing car seat manufacture line.

For this, a new installation of the smart car seat assembling facility and a manufacture line might bring to a simple solution; however owing to the increased investment for a new facility the unit price of the product inevitably increases, and the quality of a smart car seat product might become bad.

### SUMMARY OF THE INVENTION

Accordingly, it is an object of the present invention to provide a smart car seat manufacture method which features in that the manufacture of a smart car seat to which a smart concept is adapted along with an illuminating effect is easy, and an engaged state of a light emitting raw sheet providing an illuminating effects can be intensively cared, and the reliability of products can be enhanced by way of a smart performance check.

To achieve the above objects, there is a method for manufacturing a smart car seat, comprising a smart pad loading process in which a cushion pad assembly is assembled with a cushion cover covered on a cushion pad, and a back pad assembly is assembled with a light emitting raw sheet sewed on the back cover so as to form a portion which is exposed to the outside along with the back cover covered on the back pad; a seat frame loading process in which a seat belt is assembled to the cushion frame or the back frame along with a power apparatus including a recliner for the tilting of a seat, a pumping device for adjusting the height of the seat and a seat track for the sliding of a seat, and the cushion pad assembly is engaged to the cushion frame, thus engaging the back pad assembly to the back frame, and the head rest is engaged to the back pad assembly, and the cushion frame is engaged with the back frame, thus manufacturing a raw type smart car seat; an assembled state check process in which the engagement of the electric field wiring of the raw type smart car seat and the power apparatus and the wrinkles of the seat and the bent degree of the light emitting raw sheet are checked; a finish loading process in which a finish process member is engaged to the check-completed raw type smart car seat, thus manufacturing a smart car seat; an operation state check process in which the sliding function of the smart car seat, the heat resistance function and the power apparatus function are checked along with the illuminating effects of the light emitting raw sheet; and a shipping process the check-completed smart car seat is packed and transported and discharged from the assembly line.

In the smart pad loading process, various apparatuses including a heater pad are assembled during the assembling process of the cushion pad assembly and the back pad assembly, and a Hogring work is further conducted at multiple portions with respect to the cushion pad, the cushion cover, the back pad and the back cover, and a connector is connected to the light emitting raw sheet for the purpose of transmitting different colors of light in the directions of the end portions out of the portions sewed with the back cover toward the light emitting raw sheets.

After the Hogring work is finished, it is checked if the sewed finish portion of the light emitting raw sheet is over bent while checking the Hogring state.

In the smart pad loading process, the light emitting raw sheet is sewed with the back cover so as to form a portion which is exposed to the outside from at least two portions.

In the seat frame loading process, the back frame and the back pad assembly are engaged with each other by way of the protector engaging process with respect to a plurality of portions, and the cushion frame and the cushion pad assembly are engaged with each other by way of another protector engaging process with respect to a plurality of portions, and the cushion frame and the back frame are engaged with each other by way of a bolt.

After the protector engaging process is finished, it is checked if the sewed finish part of the light emitting raw sheet is over bent.

In the assembled state check process, a wrinkle removing work is further performed if necessary after the seat wrinkle state is checked.

In the finish loading process, the finish process member comprises a shield cover engaged to the cushion frame, and there is provided a back board engaged to the back frame.

The back board is engaged with the back frame after the head rest is first disengaged, and then the head rest is engaged to the back pad after the back board and the back frame are engaged.

In the operation state check process, the sliding function is performed using a sliding checker for the purpose of checking the seat sliding operation state, and the heat resistance function is performed using a heating checker which is configured to transmit a near infrared ray to the cushion cover including the light emitting raw sheet and to the back cover, and the illuminating effects of the light emitting raw sheet are obtained using a smart apparatus which is configured to generate different color light in response to the various information that the vehicle experiences and to provide it to the light emitting raw sheet.

To achieve the above objects, there is provided a smart car seat, comprising a cushion pad assembly which has a cushion pad covered with a cushion cover; a back pad assembly which has a light emitting raw sheet sewed with the back cover so that a portion exposed to the outside from the back cover covered on the back pad is formed at least two portions; a cushion frame to which the cushion pad assembly is engaged and to which a shield cover is engaged to both side portions along with a lever member; a back frame which is engaged with the cushion frame and in which the portion engaged with the back pad assembly is hid behind the back board; a head rest which is detachably engaged to the back pad assembly; and a smart controller which is installed in the back frame portion and is configured to make illuminating effects on the light emitting raw sheet with the aid of a LED light source controlled in response to various information that the vehicle experiences.

In the light emitting raw sheet, a connector is connected to the end portions out of the portions sewed with the back cover, and the connector is connected with the LED.

### ADVANTAGEOUS EFFECTS

The present invention is directed to providing an easier manufacture as well as a good product quality and enhanced product reliability in terms of the smart car seat that a smart concept is adapted to, along with various illuminating effects.

The present invention features in that an existing car seat manufacture process and a manufacture facility can be in maximum adapted to a smart car seat manufacture process that a smart concept is applied for, along with various illuminating effects, so the applicable range of the existing car seat manufacture line can be greatly enhanced.

In addition, the present invention can provide a smart car seat manufacture process having a greatly enhanced applicability in an existing car seat manufacture process and a manufacture facility, so the rise of cost needed for the development of a smart car seat manufacture process can be minimized, and it is possible to prevent the decrease of product quality which might occur due to the increased unit price of the smart car seat.

The smart car seat of the present invention has an enhanced product quality by providing various illuminating effects, and the sounds and luminance inside or outside the vehicle or the openings of doors or the fastened states of passengers' seat belts can be indicated and recognized by way of illuminations, so the five feelings and entertainment emotion can be more maximized.

### BRIEF DESCRIPTION OF THE DRAWINGS

FIGS. 1 and 2 are views illustrating the processes of a smart car seat manufacture method according to the present invention.

FIGS. 3 to 10 are views illustrating the work states of a smart car seat manufacture process according to the present invention.

FIG. 11 is a view illustrating a construction of a smart car seat according to the present invention.

### DESCRIPTION OF SPECIFIC EMBODIMENTS

The embodiments of the present invention will be described with reference to the accompanying drawings and might be implemented in many different ways from an ordinary person skilled in the art and are not limited to the following descriptions.

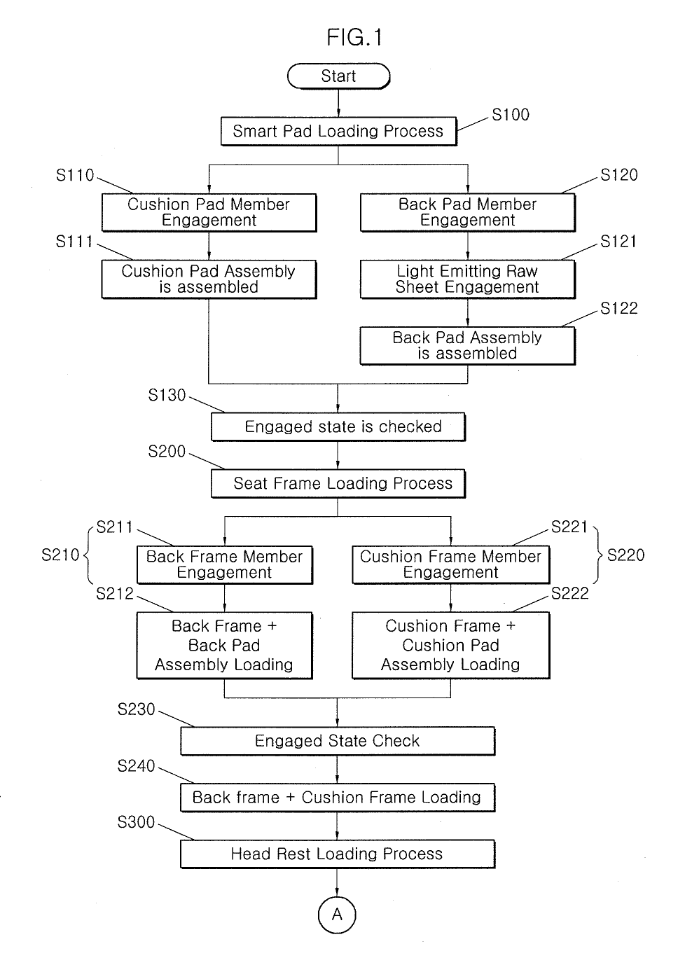

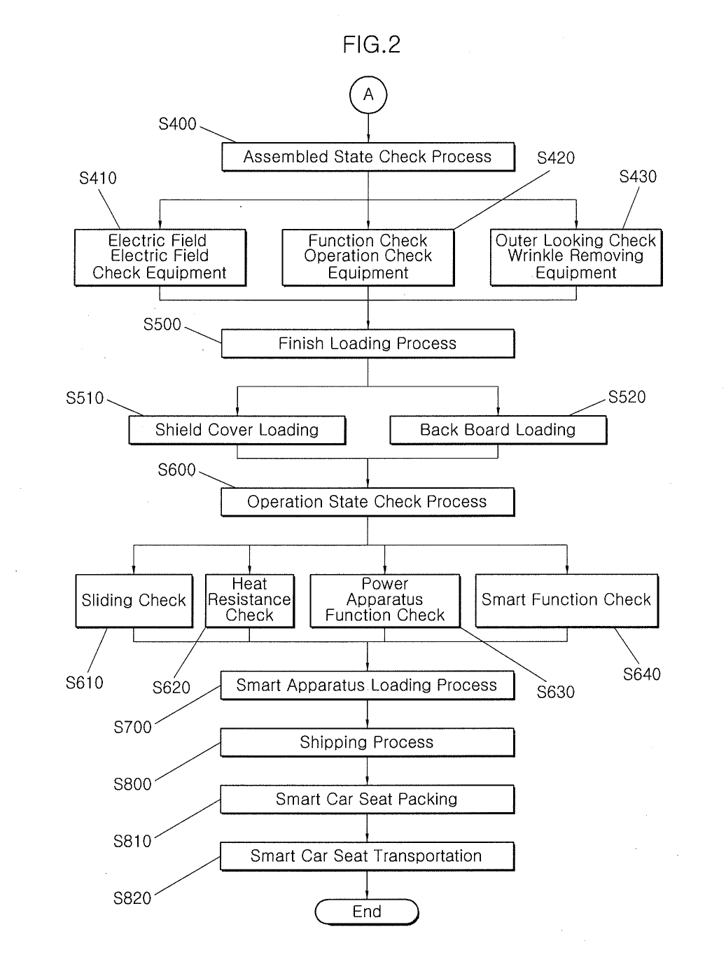

FIGS. 1 and 2 are views illustrating the processes of a smart car seat manufacture method according to the present invention.

As shown therein, the smart car seat with the illuminating effects is manufactured by way of a smart pad loading process S100, a seat frame loading process S200, a head rest loading process S300, an assembled state check process S400, a finish loading process S500, an operation state check process 5600, a smart device loading process 5700 and a shipping process S800. The manufacture of the smart car seat is finished as each process is sequentially finished.

The illuminating effects adapted to the present invention are directed to expressing on the car seats the sound and the luminance inside and outside the vehicle, the opened states of the doors, the seat belt fastened state of the passenger and the over speed of the vehicle, which is one example of the smart concepts. The illuminating effect might be substituted with another function in the smart concepts.

S100 is directed to a smart pad loading process which is formed of a cushion pad assembling process in which cushion pad members are engaged in S110, and a cushion pad assembly is manufactured in S111, and a back pad assembling process in which the pack pad members are engaged in S120, and a light emitting raw sheet is engaged together in S121, and a back bad assembly is manufactured in S122.

The light emitting raw sheet is generally woven in a texture weaving method that a warp and a weft are crossing from each other.

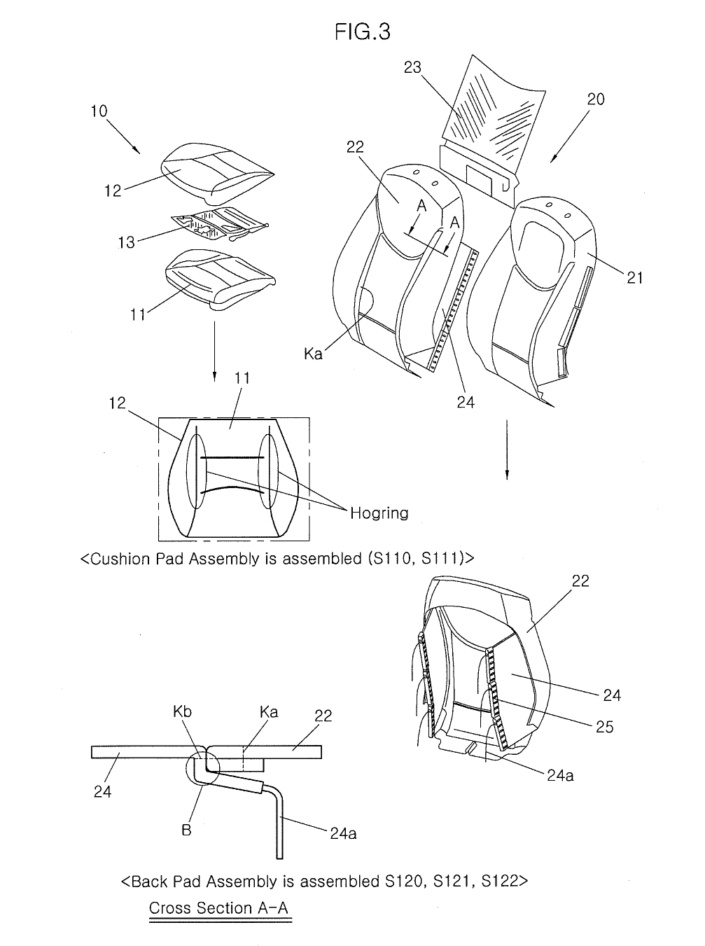

Like the cushion pad assembling process as shown in FIG. 3, the cushion pad member comprises a cushion pad 11, a cushion cover 12 engaged to the cushion pad 11 and a cushion heater 13 disposed between the cushion pad 11 and the cushion cover 12. As the above mentioned elements are engaged, a cushion pad assembly 10 is manufactured.

The cushion pad 11 is formed of a cushion foam, and the cushion cover 12 is made from a known cover material including leather, etc. The cushion heater 13 includes a heater for heating.

In the above mentioned assembling process, some necessary elements might further included in the cushion pad assembly 10 for the sake of the functions of the car seat, the work for which is performed in the middle of the engagement of cushion pad 11, the cushion cover 12 and the cushion heater 13.

During the above mentioned assembling process, Hogring works are performed at six portions between the cushion pad 11 and the cushion cover 12, by way of which the cushion pad assembly 10 comes to define a good outer looking of a car seat.

The Hogring process is directed to providing the seat with curved shapes.

In the back pad assembling process of FIG. 3, the back pad member comprises a back pad 21, a back cover 22 coupled to the back pad 21, a cushion heater 23 disposed between the back pad 21 and the back cover 22 and a light emitting raw sheet 24 sewed at the back cove 2. As the above mentioned elements are connected, a back pad assembly 20 is thus manufactured.

The back pad 21 is generally formed of a cushion foam, and the back cover 22 is made from a cover material including leather, etc., and the cushion heater 23 has a heater for heating, and the light emitting raw sheet 24 is woven with a light emitting raw thread which is configured to emit light as it receives light.

In particular, the light emitting raw sheet 24 is connected with a connector 25 by way of the light emitting raw thread 24a which receives a LED light source, and the connector 25 can be provided in a state that it is engaged with the light emitting raw sheet 24 or it is disengaged from it.

In the sewing process for the back cover 22, an end portion is folded and sewed so that an end sewing line Ka appears folded, and in the sewing process for the light emitting raw sheet 4, it is sewed so that a connection sewing line Kb can be formed at a finishing part B surrounding the end portion folded by the end sewing line Ka.

Here, it should be careful that the finishing part B where the light emitting raw sheet 24 is sewed along with the back cover 22 is not over bent.

Throughout the above mentioned assembling process, Hogring works are performed on at least 11 portions between the back pad 21, the back cover 22 and the light emitting raw sheet 24, so the back pad assembly 20 comes to have a good outer looking in the form of a car seat.

S130 is directed to checking the completion state of the assembling process for the cushion pad assembly 10 and the back pad assembly 20, during which process a worker checks visually the Hogring states and the over bent states with respect to the finishing part B of the light emitting raw sheet 24.

S200 belongs to a frame loading process which is formed of a back frame and back pad assembly loading process S210 and a cushion frame and cushion pad assembly loading process S221.

The back frame and back pad assembly loading process S210 is directed to manufacturing a back frame by way of a back frame member engagement S211 and to a loading process in which the back pad assembly and back frame are engaged S220, so the back pad assembly is assembled with the back frame.

At this time, the cushion frame member might be formed along with a bolster a forward protrusion of which can be adjusted.

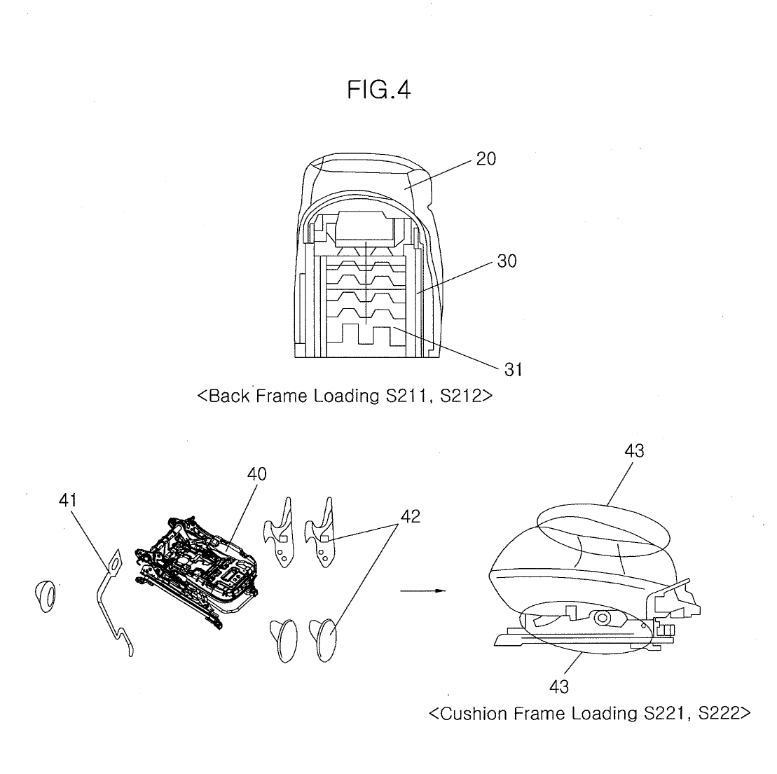

Like the back pad assembly and back frame loading process of FIG. 4, the back frame 30 and the back pad assembly 20 are fixedly engaged with a protector 31, and the protector 31 are engaged in at least 7 portions.

The engaging work of the protector 31 is performed with the back cover 22 of the back pad assembly 20 being turned inside out, so it should be careful for the workers not to over bend the light emitting raw sheet 24 during the works.

The cushion frame and cushion pad assembly process S220 feathers in that a cushion frame is manufactured by way of a cushion frame member engagement of S221, and the loading process S222 is performed, in which the cushion pad assembly and the cushion frame are engaged, so the cushion assembly comes to engaged with the cushion frame.

Like the cushion frame assembly process of FIG. 4, to the back frame member are engaged the seat belt 41 and the inside cover 42, thus assembling the cushion frame 40.

In the cushion frame member are provided a seat track and a walk-in for the sake of a seat sliding and a recliner for the sake of a seat tilting or a pumping device for the sake of a seat height adjustment. A power apparatus might be further provided if necessary.

Like the cushion frame and the cushion pad assembly loading process, the cushion frame 40 and the cushion pad assembly 10 are fixedly engaged by way of a protector 43, and the protector 43 is engaged at about 4 portions.

In S230, the cushion pad assembly 10 and the cushion frame 40 are engaged in the form of a module, and the engaged states are visually checked after the back pad assembly 20 and the back frame 30 are engaged. Here, the over bent states of the light emitting raw sheet 24 are carefully checked.

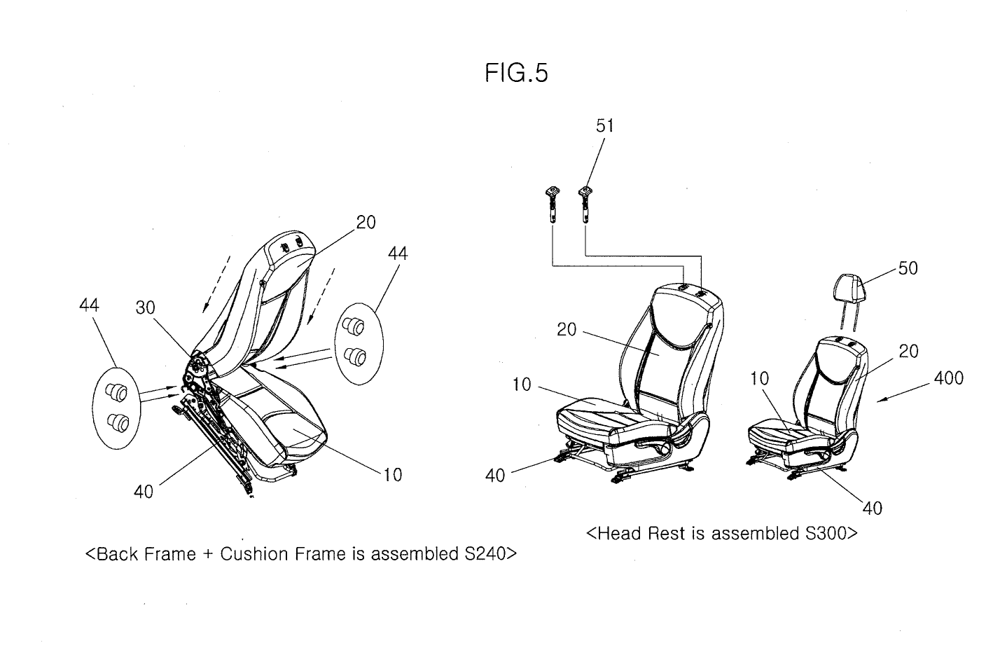

S240 belongs to a loading process interconnecting the module formed of the cushion pad assembly 10 and the cushion frame 40 and the module formed of the back pad assembly 20 and the back frame 30, the construction of which is formed in such a way that the back frame 3 and the cushion frame 40 are fixedly engaged by way of a bolt 44 as shown in FIG. 5.

S300 belongs to a head rest loading process. As shown in FIG. 5, the guide 51 belonging to the head rest is first assembled to the back pad assembly 20, and the cushion form 5 is engaged to the guide 51.

As the assembly of the head rest is finished, a raw type smart car seat is finished, which is formed of the cushion pad assembly 10, the back pad assembly 20, the back frame 30 and the cushion frame 40 and the head rest.

Here, the raw type smart car seat represents a state that the manufacture is not finished, and the smart apparatus configured to obtain the illuminating effects of the light emitting raw sheet 24 is not engaged yet.

S400 belongs to the checking process in which the assembled state of the raw type smart car seat is checked and is formed of an electric field check S410, a function check S420 and an outer looking check S430.

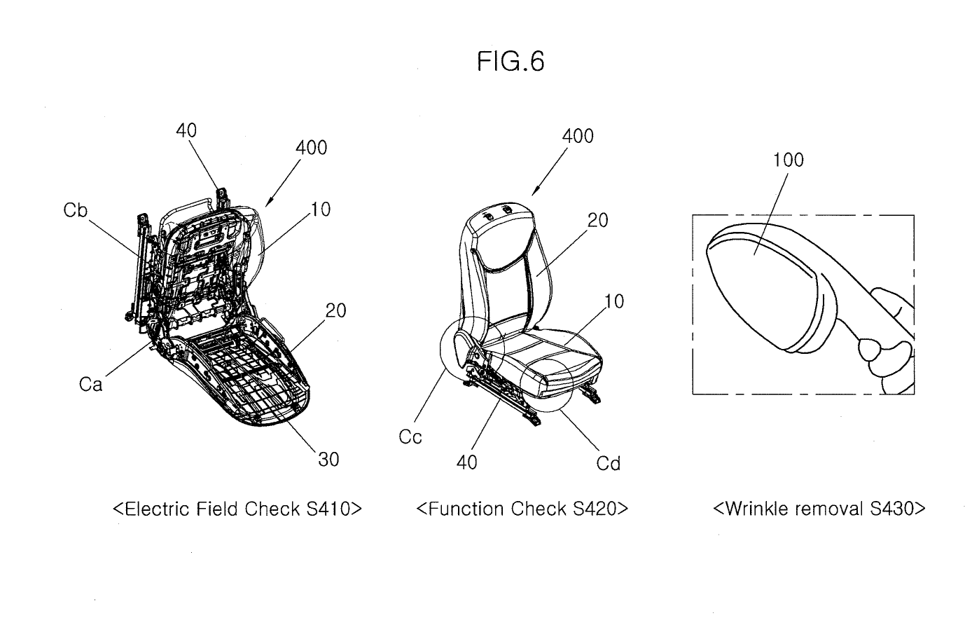

As shown in FIG. 6, in the electric field check out of S310, the wired states and the power supply state of the connector “Ca” and the wiring “Cb” with respect to the heater and power apparatus disposed in the back frame 30 and the cushion frame 40 are checked using an electric field state check equipment.

In the function check of S420, the power function, etc. such as the seat tilting “C” and the height adjustment of the seat “Cd” are checked using the operation check equipment.

In the outer looking check of S430, the wrinkles and the over bending of the light emitting raw sheet 24 are checked visually, and a wrinkle removing apparatus 100 formed of an iron using steam is used thus removing the wrinkles on the seats.

The electric field check equipment, the operation heck equipment and the wrinkle removing apparatus 100 are conventional car seat equipments.

S500 is directed to a finish loading process for the sake of a finishing work of the raw type smart car seat 400 and features in that the cushion frame is finish-processed using a shield cover like S510 and a back frame finish process using a back board like S520.

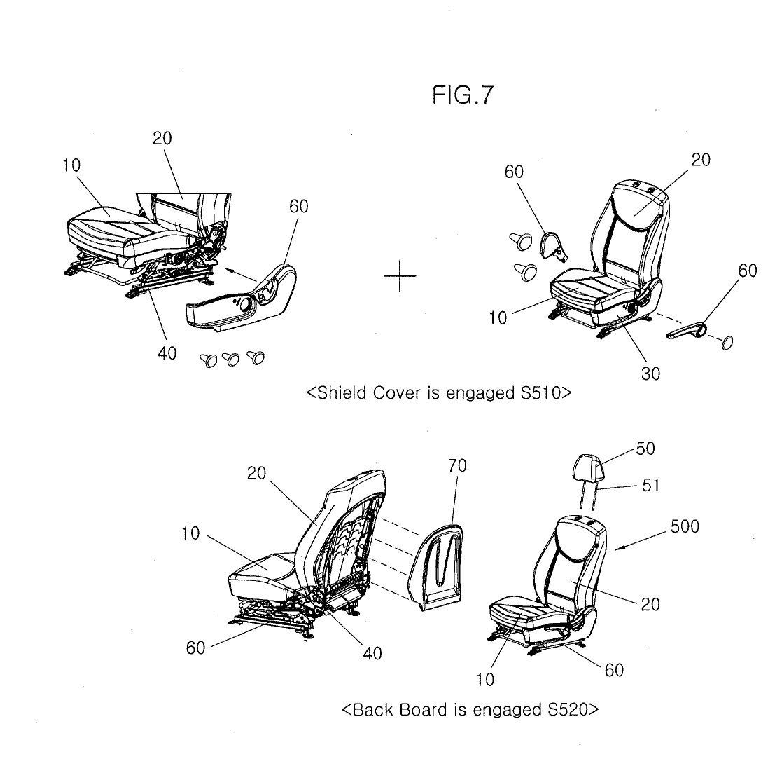

As shown in FIG. 7, the shield cover engaging work of S510 is performed as the shield cover 60 is engaged with a cushion frame 40 by way of a bolt or a screw, and a lever, etc. might be further assembled for the sake of the operation of a power apparatus during the work.

The backboard engaging work of S520 is performed as the back board 70 is engaged to the back frame 30. During the work, it is needed to first disengage the cushion foam 50 of the head rest from the back pad assembly 20.

The cushion foam 50 is engaged again to the back pad 20 after the back board 70 is engaged to the back frame 30.

As the shield cover 60 and the back board 70 are assembled to the raw type smart car seat 400, the smart car seat 500 is finished.

In this case, a smart apparatus for the purpose of obtaining the illuminating effects of the light emitting raw sheet 24 is not still mounted in the smart car seat 500; however it can be assembled in the assembly line if necessary as the smart apparatus is manufactured by the unit of a separate module or can be assembled at the site.

S600 belongs to the check process with respect to the smart car seat 500 and is formed of a sliding check S610, a heat resistance check S620, a power apparatus function check S630 and a smart function check S640.

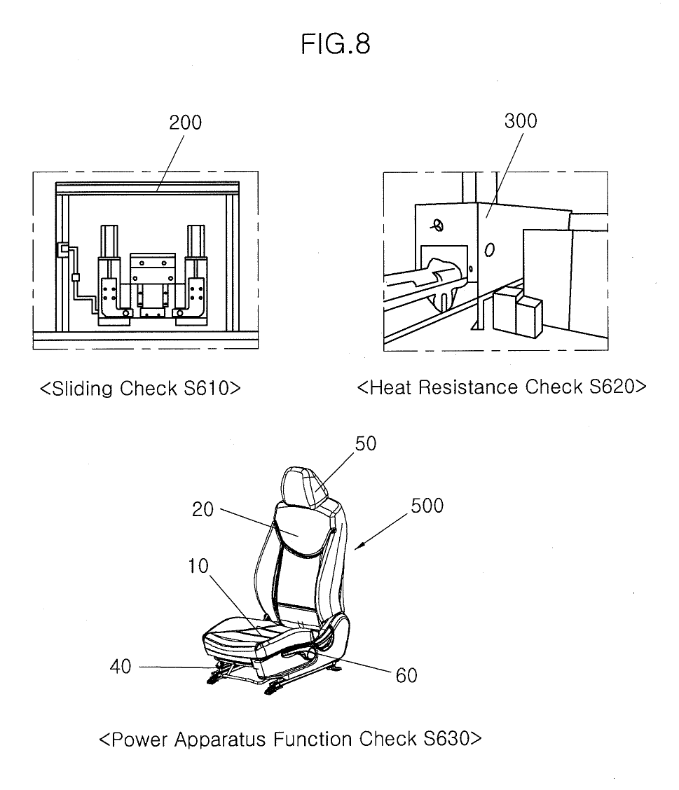

As shown in FIG. 8, the sliding check of S610 is directed to checking a sliding operation state of the seat using a seat track or a walk-in, for which a sliding checker 200 is adapted.

In the heat resistance check of S620, the heat resistance is checked with respect to the light emitting raw sheet 24 and the seat cover in such a way to emit a near infrared ray to the seat, for which a heating checker 300 emitting a near infrared ray is adapted.

After the above mentioned works are finished, the wrinkles on the light emitting raw sheet 24 and the seat cover are checked, a proper work is performed if necessary.

In the power apparatus operation check of S630, the power seat function including the tilting operation state of the recliner and the seat height adjusting operation state using the pumping device are checked, for which the power checking apparatus is adapted.

The sliding checker 200, the heating checker 300 and the power checking apparatus are conventional apparatuses for checking the functions and performance of the car seat.

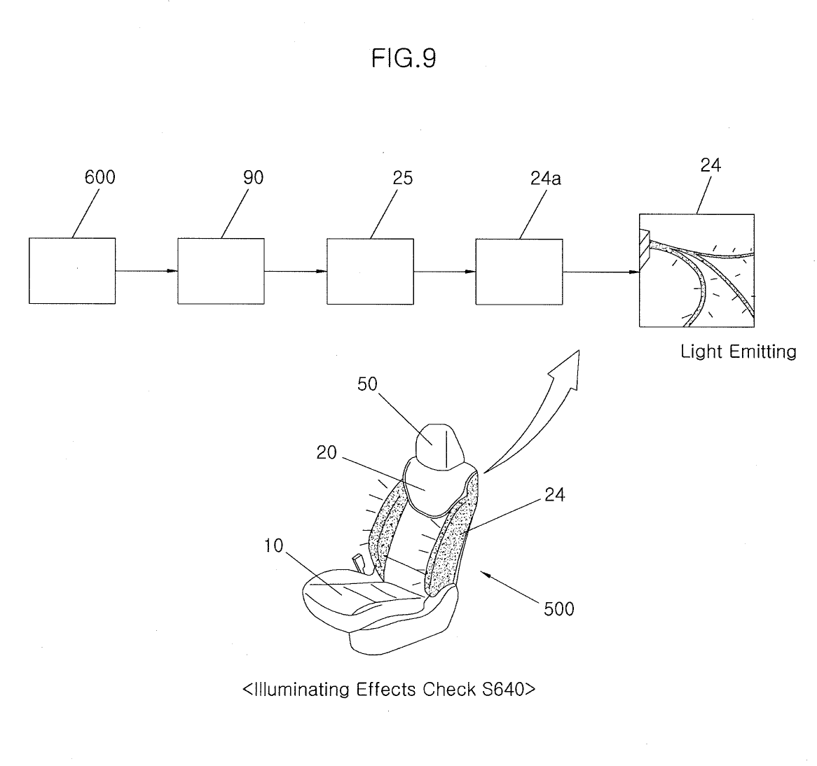

In the smart function check of S640, the smart apparatus as shown in FIG. 9 is adapted, and it is checked if the illuminating effects with respect to the light emitting raw sheet 24 operate normally.

The illuminating effects mean that the color changes of the light emitting raw sheet 24 operate normally in response to the sound and luminance inside or outside the vehicle, the opening of the door or the fastened state of the safety belt of the passenger or the over speed of the vehicle.

For the sake of the above checks, the smart apparatus features in that the connector 25 connected to the light emitting raw sheet 24 is connected with the smart controller 90, and the smart controller 90 is connected with the smart information detector 600.

Smart information might be provided to the smart information detector 600 or the smart controller 90 with the aid of a certain logic, and the smart information detector 600 might further comprise a condition generation apparatus for the purpose of detecting smart information.

In addition, the connector 25 might be supplied in the form of a separate module, not in a state that it is connected to the light emitting raw sheet 24.

When the illuminating effects are checked, the LEDs disposed at the connector 2 emit different color lights in accordance with an output signal of the smart controller 90, and as the LED light is transmitted to the light emitting raw sheet 24 by way of the light emitting raw thread 24a, it can be checked if the light emitting raw sheet 24 has normal color changes in compliance with the check conditions.

The smart apparatus loading process of S700 is directed to a process that all the assembling processes are finished with respect to the smart car seat 500 as the smart car seat 500 is assembled along with the smart apparatus after the sliding check, the heat resistance, the power apparatus function check and the smart function check are normally finished.

The smart apparatus loading process might be contained in the smart car sheet manufacture process the reasons of which are because the smart apparatus might be not assembled along with the smart car seat as the smart apparatus is manufactured in the form of a separate module.

S800 is directed to a shipping process that the smart car seat 500 is produced from the assembling line and is formed of a smart car seat packing process S810 and a smart car seat transportation process of S820.

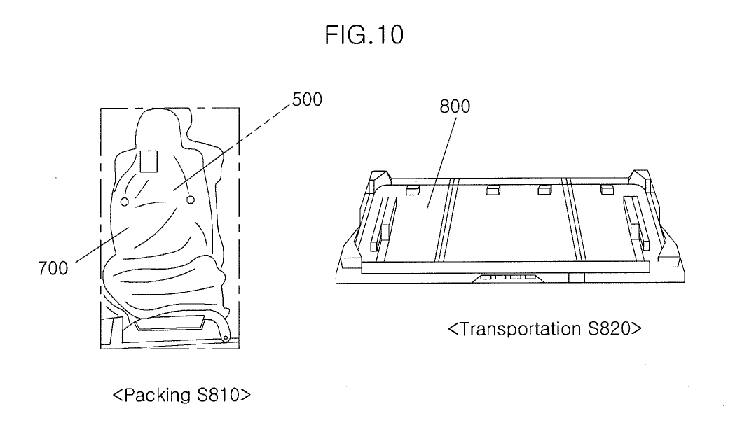

As shown in FIG. 10, the smart car seat packing process of S810 is directed to a work for the purpose of interrupting the input of different substances by packing with the packing material 700 made from a vinyl material, and the smart car seat transportation process of S820 is directed to a work for loading the packing smart car seat 500 onto a transportation machine using a palette and shipping out it.

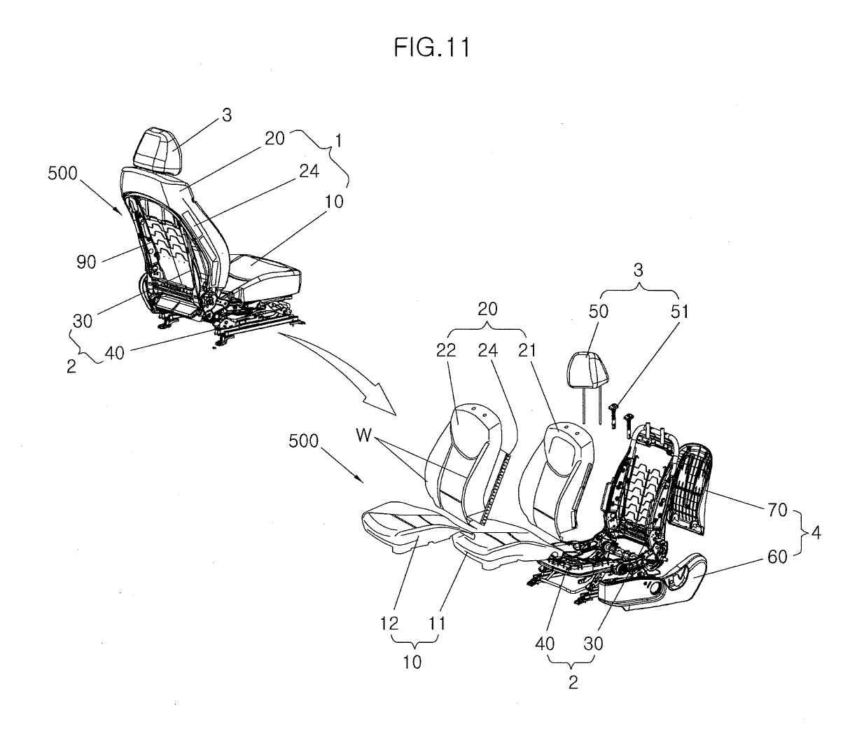

FIG. 11 is a view illustrating an example of the smart car seat 500 which is finished by way of the smart pad loading process, the frame loading process and the finish loading process, and at least two more check processes are further performed.

As shown therein, the smart car seat 500 comprises a cushion unit 1 on which a passenger can sit and which has a light emitting raw sheet 24 woven with a light emitting raw thread, thus generating different color lights to the outside, a frame unit 2 defining the frame of the cushion unit 1, a head rest 3, a sub-frame 4 for the sake of a finish process, and a smart controller 90 controlling the LED light source provided to the light emitting raw sheet 24.

The cushion unit 1 comprises a cushion pad assembly 10 on which a passenger can sit, and a back pad assembly 20 having a light emitting raw sheet 24 against which a sit passenger can lean and which generates different colors in response to the input different LED light sources.

The cushion pad assembly 10 includes a cushion pad 11 and a cushion cover 12, and the back pad assembly 20 includes a back pad 21 and a back cover 22, and the light emitting raw sheet 24 is formed along with the back cover 22.

It is common that the light emitting raw sheet 24 is configured to be exposed to the outside of the back pad assembly 20, and preferably it is sewed with the back cover 22 for the purpose of forming a light emitting part “W” which is exposed to the outside from the left and right side portions of the back pad assembly 20.

The frame unit 2 is formed of a cushion frame 40 to which the cushion pad assembly 10 is engaged, and a back frame 30 to which the back pad assembly 20 is engaged. Various apparatuses which are operable as the power seats like the recliner, the pumping device, the seat track and the walk-in are further provided along with the lever which is provided for controls.

The head read 3 is formed of a cushion foam 50 which is assembled using the guide 51 engaged to the back pad assembly 20, thus supporting the head of the user.

The sub-frame 4 comprises a shield cover 60 having a lever which is engaged to the cushion frame 40 by way of a bolt, and a back board 70 engaged to the back frame 30, so the cushion frame 40 and the back frame 30 of the smart car seat 500 can be finished clean.

The smart controller 90 is configured to receive a vehicle speed information, a door opening and closing information, a sound information inside or outside the vehicle and a luminance information inside or outside the vehicle, thus controlling the LED light sources by which the light emitting raw sheets 24 can generate different colors.

As described above, the smart car seat manufacture method according to the present embodiment of the present invention features in that the smart car seat 500 is manufactured in such a way that the cushion pad assembly 10 supporting the user's hips is assembled with the cushion cover 12 covered on the cushion pad 11, and the back pad assembly 20 is assembled, which supports the sit passenger's back with the light emitting raw sheet 24 sewed on the back cover 22 so as to form the portion which is exposed to the outside along with the back cover 22 covered on the back pad 21. The smart car seat 500 comprises the back frame 30, the cushion frame 40 and the light emitting raw sheet 24 processed along with the head rest 3 by way of the finish process. The smart car seat can be easily manufactured, which has the smart concepts providing different illuminating effects, and the quality and reliability of the products can be enhanced.

What is claimed is:

1. A method for manufacturing a smart car seat, comprising:
a smart pad loading process in which a cushion pad assembly is assembled with a cushion cover covered on a cushion pad, and a back pad assembly is assembled with a light emitting raw sheet sewed on the back cover so as to form a portion which is exposed to the outside along with the back cover covered on the back pad;
a seat frame loading process in which a seat belt is assembled to the cushion frame or the back frame along with a power apparatus including a recliner for the tilting of a seat, a pumping device for adjusting the height of the seat and a seat track for the sliding of a seat, and the cushion pad assembly is engaged to the cushion frame, thus engaging the back pad assembly to the back frame, and the head rest is engaged to the back pad assembly, and the cushion frame is engaged with the back frame, thus manufacturing a raw type smart car seat;
an assembled state check process in which the engagement of the electric field wiring of the raw type smart car seat and the power apparatus and the wrinkles of the seat and the bent degree of the light emitting raw sheet are checked;
a finish loading process in which a finish process member is engaged to the check-completed raw type smart car seat, thus manufacturing a smart car seat;
an operation state check process in which the sliding function of the smart car seat, the heat resistance function and the power apparatus function are checked along with the illuminating effects of the light emitting raw sheet; and
a shipping process the check-completed smart car seat is packed and transported and discharged from the assembly line.

2. The method of claim 1, wherein in the smart pad loading process, various apparatuses including a heater pad are assembled during the assembling process of the cushion pad assembly and the back pad assembly, and a Hogring work is further conducted at multiple portions with respect to the cushion pad, the cushion cover, the back pad and the back cover, and a connector is connected to the light emitting raw sheet for the purpose of transmitting different colors of light in the directions of the end portions out of the portions sewed with the back cover toward the light emitting raw sheets.

3. The method of claim 2, wherein after the Hogring work is finished, it is checked if the sewed finish portion of the light emitting raw sheet is over bent while checking the Hogring state.

4. The method of claim 1, wherein in the smart pad loading process, the light emitting raw sheet is sewed with the back cover so as to form a portion which is exposed to the outside from at least two portions.

5. The method of claim 1, wherein in the seat frame loading process, the back frame and the back pad assembly are engaged with each other by way of the protector engaging process with respect to a plurality of portions, and the cushion frame and the cushion pad assembly are engaged with each other by way of another protector engaging process with respect to a plurality of portions, and the cushion frame and the back frame are engaged with each other by way of a bolt.

6. The method of claim 5, wherein after the protector engaging process is finished, it is checked if the sewed finish part of the light emitting raw sheet is over bent.

7. The method of claim 1, wherein in the assembled state check process, a wrinkle removing work is further performed if necessary after the seat wrinkle state is checked.

8. The method of claim 1, wherein in the finish loading process, the finish process member comprises a shield cover engaged to the cushion frame, and there is provided a back board engaged to the back frame.

9. The method of claim 8, wherein the back board is engaged with the back frame after the head rest is first disengaged, and the head rest is engaged to the back pad after the back board and the back frame are engaged.

10. The method of claim 1, wherein in the operation state check process, the sliding function is performed using a sliding checker for the purpose of checking the seat sliding operation state, and the heat resistance function is performed using a heating checker which is configured to transmit a near infrared ray to the cushion cover including the light emitting raw sheet and to the back cover, and the illuminating effects of the light emitting raw sheet are obtained using a smart apparatus which is configured to generate different color light in response to the various information that the vehicle experiences and to provide it to the light emitting raw sheet.

11. A smart car seat which is manufactured using claim 1.

12. A smart car seat, comprising:
a cushion pad assembly which has a cushion pad covered with a cushion cover;
a back pad assembly which has a light emitting raw sheet sewed with the back cover so that a portion exposed to the outside from the back cover covered on the back pad is formed at least two portions;
a cushion frame to which the cushion pad assembly is engaged and to which a shield cover is engaged to both side portions along with a lever member;
a back frame which is engaged with the cushion frame and in which the portion engaged with the back pad assembly is hid behind the back board;
a head rest which is detachably engaged to the back pad assembly; and
a smart controller which is installed in the back frame portion and is configured to make illuminating effects on the light emitting raw sheet with the aid of a LED light source controlled in response to various information that the vehicle experiences.

13. The car seat of claim 12, wherein in the light emitting raw sheet, a connector is connected to the end portions out of the portions sewed with the back cover, and the connector is connected with the LED.
